(19) United States
(12) Patent Application Publication
(10) Pub. No.: US 2010/0008178 A1
(43) Pub. Date: Jan. 14, 2010

(54) Acoustic Beverage Mixer

(76) Inventor: Dale Fahrion, Bonny Doon, CA (US)

Correspondence Address: Soquel Group, LLC, P.O. Box 691, Soquel, CA, 95073, US

(21) Appl. No.: 12/172,828

(22) Filed: Jul. 14, 2008

(51) Int. Cl. B01F 11/02; B01F 11/00

(52) U.S. Cl. 366/110; 366/114; 366/127

(57) ABSTRACT

A method and device for mixing beverages and dissolving solids comprising a casing with at least one opening for positioning a beverage container, a signal generator housed within said casing, for generating electrical signals, at least one transducer housed within said casing and coupled with said signal generator, for producing mechanical vibrations from a signal generated by said signal generator, wherein said mechanical vibrations vibrate a beverage container positioned on said casing causing acoustic vibrations within the beverage inside the beverage container, said acoustic vibrations causing beverages and solids within the beverage container to mix.

### FIELD OF THE INVENTION

The field of the present invention is the use of acoustic energy to mix beverages and to dissolve solids in beverages.

### BACKGROUND OF THE INVENTION

Beverages, such as hot coffee and tea, commonly have additives such as sweeteners or creamers added. Such additives are then stirred with a stirring device such as a disposable stir stick to mix the additive with the beverage. Typically, the stir stick is disposed of after a single use. Thus, the act of mixing generates waste which is not typically recycled. An important disadvantage of the disposable stir stick is that because it is typically made of plastic, its disposal has an undesirable impact on the environment since it is not readily biodegradable. Another disadvantage of disposable stir sticks is that they present a recurring cost to the merchant that must procure them.

A common alternative to the use of disposable stir sticks is the use of a re-usable utensil such as a metal spoon which then must be washed between uses. The use of a washable spoon requires additional expenses of labor and energy.

Thus there is a need for an improved device that enables beverages to be mixed without the use of disposable stir sticks and without the added expense of washing reusable utensils.

Other devices, commonly found in laboratory environments, exist for mixing liquids and dissolving solids. Generally, an element of such a device, such as a probe, comes into contact with the specimen which is being mixed or dissolved. One such device utilizes a rotary motor, external to the specimen, which couples its motion magnetically to a ferrous puck which is submerged in the specimen.

Thus there is a need for an improved method that enables beverages to be mixed in an entirely sanitary manner that does not entail contact with the beverage.

The present invention makes use of an acoustic transducer, also referred to as a sonic transducer, or simply transducer, which converts electrical pulses to mechanical vibrations. Mechanical vibrations are referred to as acoustic vibrations, waves, or acoustic waves as they travel through gases, solids and liquids. The active element of most acoustic transducers used today is a piezoelectric crystal (also referred to as a piezoelectric ceramic, piezoelectric ceramic wafer or piezoelectric wafer). A piezoelectric crystal deforms in shape when an electrical signal is applied to it thus generating a mechanical vibration. While a transducer generically refers to a device that converts one form of energy to another, the term actuator is often used to refer to a component that converts electrical energy to mechanical energy. Further, a piezo actuator is a type of actuator that uses a piezoelectric crystal.

Actuation modes are specific mechanical vibration patterns that may be emitted from the transducer. Actuation modes may be relatively simple in the case of a positive and negative displacement along a single axis of a transducer. The displacement is typically a result of the transducer expanding and contracting evenly across its surface. More complex actuation modes may include positive and negative displacement along multiple axes of a transducer. When the displacement occurs on multiple axes the vibration mode may be represented as an oscillation between a concave and convex transducer surface.

Acoustic transducers oscillate in a fixed, constant-frequency contraction-extension vibration mode. The typical actuation mode of oscillation can be described when a given dimension of the transducer is periodically changing length. These shape changes tend to follow a simple sinusoidal function. Conventional acoustic transducers require an oscillating electrical signal as input. This oscillating input produces an oscillating mechanical contraction/extension of proportional amplitude. The frequency of the electrical input signal is sometimes relatively constant and sometimes sweeps a narrow frequency band, or range, around a central operating frequency.

Acoustic energy transmitted through liquids as acoustic vibrations is commonly used in industrial cleaning systems. Industrial sonic cleaning systems work by producing sound waves in liquids, typically in the ultrasonic range of approximately 20 kHz to 270 kHz. The waves consist of both high- and low-pressure fronts. The low-pressure fronts have a low enough localized pressure to cause bubbles to form. The high-pressure fronts cause the bubbles to collapse or to deform. The expanding and collapsing/deforming of bubbles, referred to as “cavitation,” dislodges particles in the cleaning process. Cavitation is also known to emulsify dissolvable solids.

Thus, two effects are at play when acoustic energy is transmitted into a beverage: (1) compression and rarefaction waves, and (2) in some cases, cavitation.

### SUMMARY OF THE DESCRIPTION

Aspects of the present invention relate to an acoustic beverage mixing device, henceforth referred to as “acoustic beverage mixer”, for mixing beverages using acoustic energy. More specifically, the acoustic beverage mixer generates and transmits acoustic energy through a beverage container into the liquid within causing the beverage to mix. No part of the acoustic beverage mixer comes into contact with the beverage. The acoustic energy causes the beverage, such as coffee or tea, to mix with other added fluids such as creamer, and causes added solids such as sweeteners to dissolve.

The acoustic beverage mixer works with beverage containers made from a variety materials including paper, ceramic, plastic and metal.

The acoustic beverage mixer provides a physical guide that enables a user to position a beverage container within the acoustic beverage mixer. In one embodiment, the acoustic beverage mixer transmits acoustic energy through the bottom of the beverage container and into the beverage. The transducer may contact the bottom of the beverage container but it does not contact the beverage itself.

The device may also include the following additional capabilities including inter alia a mechanical start and stop function, an automatic start and stop function based upon sensing the presence of a beverage container, a timer to automatically turn off the device after a preset time period, and an indicator light that illuminates when the device is operating.

In a second embodiment, acoustic energy is transmitted into the beverage through the side of the beverage container. In this case, the transducer may contact the side of the beverage container but it does not contact the beverage itself.

A third embodiment of this invention, a multiple station acoustic beverage mixer, combines multiple beverage mixing stations into a single device. In this embodiment, a single source of power is shared by all stations while each of the mixing stations includes a separate source of acoustic energy and each mixes a single beverage.

### BRIEF DESCRIPTION OF THE DRAWINGS

The present invention will be more fully understood and appreciated from the following detailed description, taken in conjunction with the drawings in which:

FIG. 1 is a simplified block diagram of an acoustic beverage mixing device that mixes beverages and dissolves solids, in accordance with an embodiment of the present invention;

FIG. 2 is a simplified block diagram of the electronic components of an acoustic beverage mixing device that mixes beverages and dissolves solids, in accordance with an embodiment of the present invention;

FIG. 3 is a simplified mechanical drawing that illustrates a cross section of an acoustic beverage mixing device in which acoustic energy is transmitted through the bottom of the beverage container, in accordance with an embodiment of the present invention;

FIG. 4 is a simplified mechanical diagram of an acoustic beverage mixing device in which acoustic energy is transmitted through the side of the beverage container, in accordance with an embodiment of the present invention; and

FIGS. 5A-B are simplified mechanical drawings that show the construction of an acoustic beverage mixing device capable of mixing multiple beverages simultaneously, in accordance with an embodiment of the present invention.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods, or devices. Accordingly, the present invention may take the form of an entirely hardware embodiment or an embodiment combining software and hardware aspects. The following detailed description is, therefore, not to be taken in a limiting sense.

Aspects of the present invention concern a device and methods for mixing beverages such as coffee and tea with additives such as milk and sugar.

As used herein the following terms have the meaning given below:

Mixing—means to mix two beverages together, for example coffee and cream or to mix a solid, such as sugar, into a liquid such as tea. Mixing may refer to increasing the rate at which two liquids are mixed or increasing the rate at which a solid is dissolved and uniformly mixed with a liquid. Mixing may further mean mixing a plurality of liquids and/or solids together.

Beverage—means a liquid that is drunk by a user.

Beverage container—means a cup, can, mug or other container that contains a beverage. No limitation is placed on the type of beverage container.

Beverage mixing station—means a location on the acoustic beverage mixer where a user places a beverage container. For example, in one embodiment an acoustic beverage mixer provides a single beverage mixing station and thus can mix a single beverage at a time. In another embodiment, an acoustic beverage mixer provides multiple beverage mixing stations and thus can mix multiple beverages simulataneously.

User—means a person that uses an acoustic beverage mixer to mix his beverage.

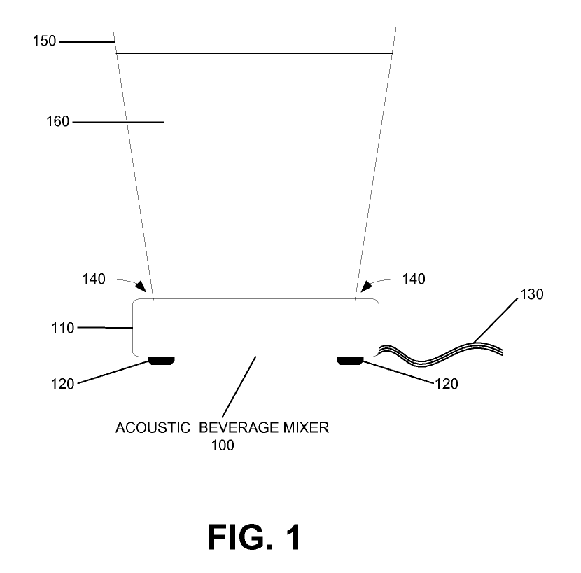

Now reference is made to FIG. 1, which is a simplified block diagram of an acoustic beverage mixer that mixes beverages and dissolves solids, in accordance with an embodiment of the present invention. An acoustic beverage mixer 100 is an electronic device that has a casing 110, and includes one or more feet 120 and a power cord 130.

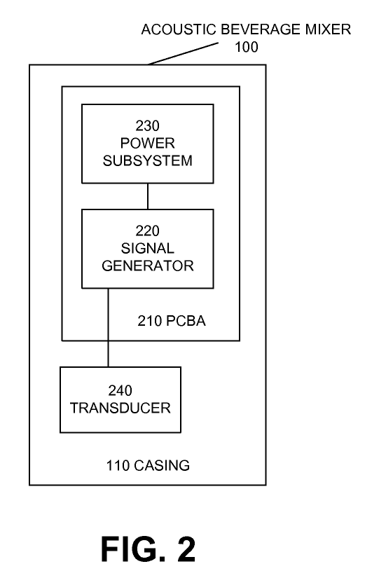

The electronic components attached on the inside of casing 110 are described in detail with reference to FIG. 2. In one embodiment casing 110 is formed of molded plastic. In general, casing 110 is water resistant and has an outer surface that can be easily wiped clean. Casing 110 rests on top of one or more feet. The feet are typically made of hard rubber or another material that absorbs shock and will not break if acoustic beverage mixer 100 falls onto the floor. Power cord 130 connects acoustic beverage mixer 100 to a source of electrical energy.

In one embodiment, acoustic beverage mixer 100 includes an opening 140 into which a user positions a beverage container 150. The opening serves as a physical guide that enables correct positioning of the beverage container. Optimal results are obtained when a user centers the beverage container inside opening 140. Acoustic beverage mixer 100 generates acoustic energy and directs such acoustic energy through the bottom of beverage container 150 into beverage 160.

Now reference is made to FIG. 2 which is a simplified block diagram of the electronic components of an acoustic beverage mixer that mixes beverages and dissolves solids, in accordance with an embodiment of the present invention. As depicted in FIG. 2, acoustic beverage mixer 100 includes as primary components a printed circuit board assembly (PCBA) 210 that includes a power subsystem 230 and a signal generator 220, and a transducer 240. PCBA 210 and transducer 240 are held in place by a casing 110.

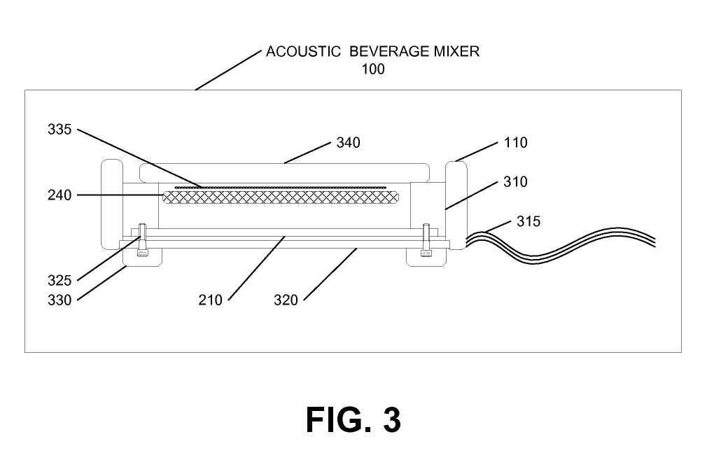

Power subsystem 230 prepares the electric input for use by signal generator 220. Signal generator 220 produces an oscillating electrical signal of sufficient amplitude and frequency to drive transducer 240. Transducer 240 transforms the electrical signal supplied by signal generator 220 into acoustic vibrations. In one embodiment, transducer 240 is composed of a piezoelectric wafer that generates a mechanical vibration. In one embodiment, the frequency of the vibration is in the ultrasonic range which is generally understood to mean over 20,000 Herz. Casing 110 provides a mechanical coupling between PCBA 210, transducer 240 and casing 110 such that transducer 240 is held at the top of the assembly. Casing 110 and the physical attachment of PCBA and transducer 240 to casing 110 are described in greater detail with reference to FIG. 3

Acoustic beverage mixer 100 may be placed in an operable or non-operable state. In one embodiment acoustic beverage mixer 100 can be turned on, i.e. placed in an operable state, using a mechanical on/off switch. In another embodiment, a sensor automatically detects when a beverage container is placed in acoustic beverage mixer 100 and automatically places acoustic beverage mixer 100 into an operable state. When acoustic beverage mixer 100 is in an operable state and a beverage container is positioned correctly inside opening 140 the mechanical vibration provided by transducer 240 is transmitted through beverage container 150 bottom into beverage 160. The action of the acoustic energy that enters beverage 160 induces compressive and rarefaction waves that propagate through the liquid that cause mixing of liquids and solids within beverage container 150. In one embodiment, these compressive and rarefaction waves are of sufficient energy to cause cavitations, i.e. the rarefaction causes the local pressure in the fluid to be reduced to a value less than its vapor pressure.

Transducer 240 may exhibit specific actuation modes that vary in direction and amplitude and may vibrate in one axis only or in multiple axes. These acoustic vibrations may be emitted by the transducer in the x, y, z directions or in a combination of all directions so as to optimize the effect on the beverage to enable mixing and dissolving of added solids such as sweeteners. In one embodiment transducer 240 expands/contracts along a single axis. For example, a flat piezoelectric disc that only changes thickness will produce such an effect.

In one embodiment, acoustic beverage mixer 100 also includes a timer to automatically turn off the device after a preset time period. In another embodiment, acoustic beverage mixer 100 also includes an indicator light that illuminates when the device is operating.

Now reference is made to FIG. 3 which is a simplified mechanical drawing that illustrates a cross section of an acoustic beverage mixing device in which acoustic energy is transmitted through the bottom of the beverage container, in accordance with an embodiment of the present invention. FIG. 3 illustrates the preferred embodiment of acoustic beverage mixer 100 in which transducer 240 transmits acoustic energy into beverage container 150 from the bottom. A casing 110 is used to fix in place the active electronic components including PCBA 210 and transducer 240 and to provide a platform on which to place beverage container 150. Casing 110 rests on top of four feet 120. Typically casing 110 is constructed using molded plastic; however other materials may also be used including inter alia metal alloy and hard rubber. Casing 110 includes four molded bosses 310. Each molded boss 310 is a molded feature of casing 110 that enables a screw 325 to attach PCBA 210, a bottom cover plate 320 and a foot 330 to casing 110. Typically, molded boss 310 is a section of casing 110 thick enough to accommodate a tapped screw hole. A bottom cover plate 320 fits over the bottom of casing 110. A power cord 315 connects an external source of electrical energy to power subsystem 230.

Transducer 240 is fixed, typically using an adhesive 335 on the underside of a top plate 340. In one embodiment, top plate 340 is attached to casing 110 via an elastomeric gasket which serves to attenuate the acoustic vibration into casing 110. In operation, the user places his/her beverage container on top of top plate 340.

### Second Embodiment—Side-Mounted Transducer

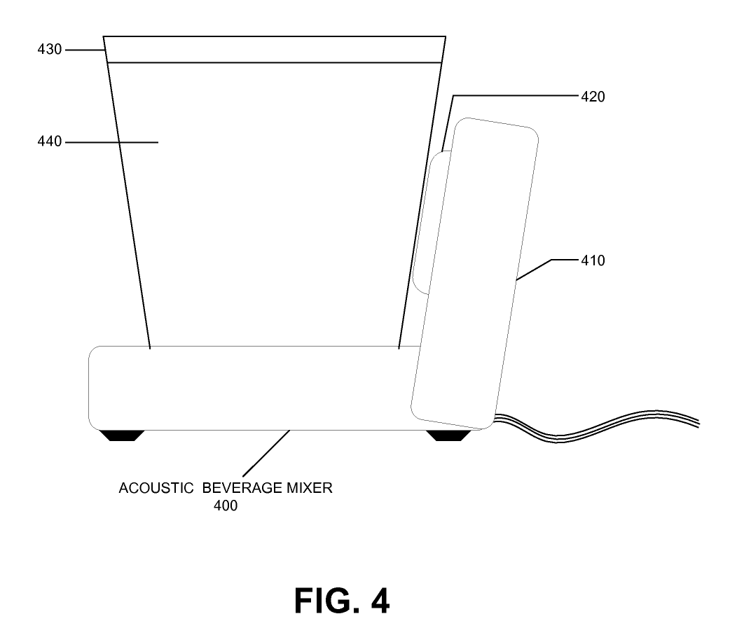

Now reference is made to FIG. 4, which is a simplified mechanical diagram of an acoustic beverage mixing device in which acoustic energy is transmitted through the side of the beverage container, in accordance with an embodiment of the present invention. An acoustic beverage mixer 400 is similar to acoustic beverage mixer 100 with the exception that transducer 240 is mounted within a side assembly 410. Side assembly 410 provides for the attachment of transducer 240 to a side plate 420. Side plate 420 generates acoustic energy and directs such acoustic energy through the side of beverage container 430 into beverage 440.

### Third Embodiment—Multiple Station Acoustic Beverage Mixer

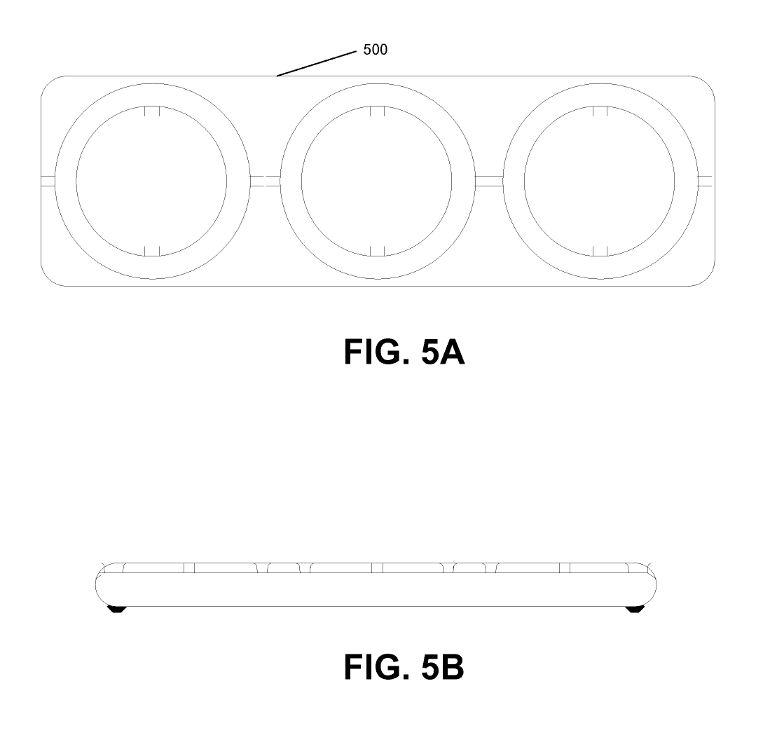

Now reference is made to FIGS. 5A-B, which are simplified mechanical drawings that show the construction of an acoustic beverage mixer capable of mixing multiple beverages simultaneously, in accordance with an embodiment of the present invention. FIG. 5A presents a top view of a multiple station acoustic beverage mixer 500 that includes three beverage mixing stations. As depicted in FIG. 5A, the three stations are part of a single, integrated unit that shares a common power subsystem. Each station includes its own signal generator and transducer. FIG. 5B presents a side view of multiple station acoustic beverage mixer 500. It will be apparent to one skilled in the art that a multiple station acoustic beverage mixer such as that depicted in FIGS. 5A-B may include an arbitrary number of mixing stations.

In reading the above description, persons skilled in the art will realize that there are many apparent variations that can be applied to the methods and systems described.

What is claimed is:

1. A device for mixing beverages and dissolving solids comprising:
a casing with at least one opening for positioning a beverage container;
a signal generator housed within said casing, for generating electrical signals; and
at least one transducer housed within said casing and coupled with said signal generator, for producing mechanical vibrations from a signal generated by said signal generator, wherein said mechanical vibrations vibrate a beverage container positioned on said casing causing acoustic vibrations within the beverage inside the beverage container, said acoustic vibrations causing beverages and solids within the beverage container to mix.

2. The device of claim 1 wherein said transducer is a piezoelectric ceramic.

3. The device of claim 1 wherein said mechanical vibrations produced by said transducer may be emitted in any combination of x, y, z directions and may vary in amplitude.

4. The device of claim 1 wherein said mechanical vibrations produced by said transducer are at a single frequency.

5. The device of claim 1 wherein said mechanical vibrations produced by said transducer are in a frequency range.

6. The device of claim 1 wherein said mechanical vibrations produced by said transducer are at a plurality of frequencies.

7. The device of claim 1 wherein said acoustic vibrations are of sufficient energy and frequency to induce cavitations in the beverage.

8. The device of claim 1 wherein said acoustic vibrations are of sufficient energy and frequency so as to induce compressive and rarefaction waves that propagate through the beverage but wherein said compressive and rarefaction waves do not induce cavitations in the beverage.

9. The device of claim 1 wherein said transducer is positioned below the beverage container and wherein said transducer directs mechanical vibrations through the bottom of said beverage container.

10. The device of claim 1 wherein said transducer is positioned on the side of the beverage container and wherein said transducer directs mechanical vibrations through the side of said beverage container.

11. The device of claim 1 with at least one opening comprises a single opening.

12. The device of claim 1 with the at least one opening comprises multiple openings to enable simultaneous positioning of multiple beverage containers and simultaneous mixing of the beverages contained therein.

13. A method for mixing beverages and dissolving solids for use in an acoustic beverage mixer comprising:
converting an electrical signal into a mechanical vibration;
generating a mechanical vibration against the surface of a beverage container;
generating by said mechanical vibration acoustic vibrations in the fluid contained therein thereby mixing any beverages and solids within the beverage container.
